(19) United States
(12) Patent Application Publication
(10) Pub. No.: US 2009/0051184 A1
(43) Pub. Date: Feb. 26, 2009

(54) Stretchers

(76) Inventor: Shahid Saleem, West Yorkshire (GB)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 11/664,946

(22) PCT Filed: Oct. 7, 2004
(86) PCT No.: PCT/GB04/04250

§ 371 Date: Oct. 10, 2008

(51) Int. Cl. A61G 1/02; B60K 8/00; B60P 3/06

(52) U.S. Cl. 296/20; 180/54.1; 410/3; 5/600

(57) ABSTRACT

A stretcher (18) has front wheels that are powered by a motor (146). An operator actuates a lever (150) to cause the wheel to be powered. The powered wheels can be moved between a position in which they are constrained to rotate about a common axis extending between the wheels to a position in which each wheel can swivel separately.

The present invention relates to a stretcher and a method of operating a stretcher.

In maneuvering stretchers into ambulances the operator has to exert a considerable force in order to push the stretcher up a steep ramp whilst, at the same time, concentrating on getting the line of the stretcher correct. The effect can be bad for the back of the operator. Furthermore, the wheels of the stretcher are mounted on swivels which, particularly if the ramp tilts to one side (such as may occur when the vehicle is not parked on level ground) as the operator pushes the stretcher up it can run off the stretcher. In addition the stretcher can run off course when going up or down hill or on a slope. Alternatively, the stretcher can run away down hill if on a steep hill or if the operator slips and loses grip. All of these problems are accentuated when the patient on the stretcher is particularly heavy.

It is an object of the present invention to attempt to overcome at least some of the above or other disadvantages.

According to one aspect of the present invention a trolley includes a patient support and at least three wheels which enable the trolley to be moved, at least one of the wheels being able to operate in a retained mode in which the wheel is constrained to rotate about a first axis only with respect to the trolley, the trolley including power means arranged, in the retained mode at least, to power the wheel to rotate about the first axis, the wheel also being able to operate in a released mode in which the wheel is able to rotate about the first axis and a second axis extending upwardly with respect to the first axis.

In the retained position, the axis of the wheel may be arranged always to be at the same angular orientation with respect to the trolley.

The trolley may include actuation means arranged to cause the wheel to be in between the retained or the released mode or both.

The actuation means may include a clutch, such as a magnetic clutch, selectively actuatable to cause the wheel to be in the retained or released mode. The clutch may be arranged to act on an axle extending from the wheel in the direction of the first axis.

The actuation means may be actuatable to hold the wheel in the retained position in one position only of the second axis.

The actuation means may include mechanically actuatable means such as manually actuatable means. The mechanically actuatable means may be actuatable to cause the wheel to be in the retained or the released mode.

The mechanically actuatable means may comprise a reciprocable member movable in the axial direction of the first axis to cause the wheel to be in the retained mode in a first axial position of the reciprocatable member and to be in the released mode in a second axial position of the reciprocatable member. The reciprocatable member may be movable against a resilient bias when moving from one of the axial positions to the other such as when moving from the retained to the released mode. The resilient bias may comprise a spring such as a compression spring. The reciprocatable member may also be movable in a rotational direction about the first axis.

The reciprocatable member may be arranged to be axially movable on an axle of the wheel. In at least one of the retained or released modes or both, the reciprocatable member may be constrained to rotate about the first axis when the wheel rotates about the first axis.

The reciprocatable member may be arranged to move axially and rotationally about the first axis when moving between the retained and the released mode.

One of the axle or the reciprocatable member may comprise a tube arranged to at least partially surround the other of the reciprocatable member or the axle. The tube and axle may include cooperating portions arranged to engage each other to prevent relative rotation in at least one of the retained or released modes and preferably both modes. The resilient means may be located within the tube.

The reciprocatable member may be arranged to co-operate with a portion spaced from the wheel in the retained mode. That portion may be fixed with respect to the trolley. The portion may be axially aligned with the first axis when in the retained mode. The reciprocatable member and that portion, when cooperating, may be prevented from relative rotation and may be constrained to rotate together.

The trolley may include power means which may be controllable by an operator. The trolley may include control means arranged to vary the rotational speed of the wheel. Alternatively or additionally, the control means may be arranged to restrict the speed of rotation of the wheel. The power means may be supplied with power from a battery mounted on the trolley.

The actuation means may comprise manually operable means, such as by the foot of the operator, arranged to permit the wheel to be in the retained mode or the released mode or both.

The power means may include a motor. The motor may be mounted on an axle connected to the wheel or, alternatively or additionally, may be mounted on the wheel. An axle from the wheel may include a magnetic portion and the motor may be arranged to induce a current to cause rotation of the axle.

At least two wheels of the trolley may be movable between the retained and the released modes. Those wheels may be located at the same end region of the trolley. In the retained mode, the first axis of each wheel may be coincident with each other. Each wheel may have its own motor mounted on an axle connected to the wheel or, alternatively or additionally, may have a motor mounted on each wheel.

Each wheel may be movable separately between the retained and released modes. Each wheel may have its own axle extending in the direction of the first axis which may, for instance, each be held in the retained mode or be in the released mode. Alternatively, each wheel may be arranged to be simultaneously in the released or the retained mode such that it is not possible to cause only one wheel to be in the retained mode or one wheel only to be in the released mode or both.

Each wheel may have a separate clutch as herein referred to or a single clutch may cause the wheels to be in the retained or the released mode.

Each wheel may have its own mechanically actuating means as herein referred to. Alternatively, a single mechanically actuatable member as herein referred to may be arranged to cause both wheels to move between the retained and released mode.

When a single mechanically actuatable means is provided this may be arranged to co-operate with an axle extending from each wheel such that, in the retained mode, the axles are connected and in the released mode the axles are not connected.

The present invention also includes a method of operating a stretcher, the stretcher including at least three wheels and a patient support, the method comprising moving at least one wheel from a released mode in which the wheel is able to rotate about its own axis and also about an upwardly extending axis to a retained mode in which the wheel is able to rotate about its own axis only and powering the wheel in at least one mode.

The method may comprise powering the wheel when in the retained mode.

The method may comprise varying the power supplied to the wheel to cause a variation in speed of the trolley.

The method may comprise exerting a restraining force on the wheel to prevent the trolley from travelling too fast.

The method may comprise maneuvering the trolley solely with the powered wheel or, alternatively or additionally, with the powered wheel and also with manual force being applied by an operator.

The method may comprise maneuvering the trolley up or down an incline, such as a ramp of an ambulance when exerting power to the wheel.

The method may comprise maneuvering a trolley when powering two wheels. The method may comprise powering one or both wheels at one end of the trolley (such as the front end) with an operator being at the other end of the trolley.

The present invention also includes a method of operating a trolley when the trolley is as herein referred to.

The present invention includes any combination of the herein referred to features or limitations.

The present invention can be carried into practice in various ways but several embodiments will now be described, by way of example, with reference to the accompanying drawings, in which:—

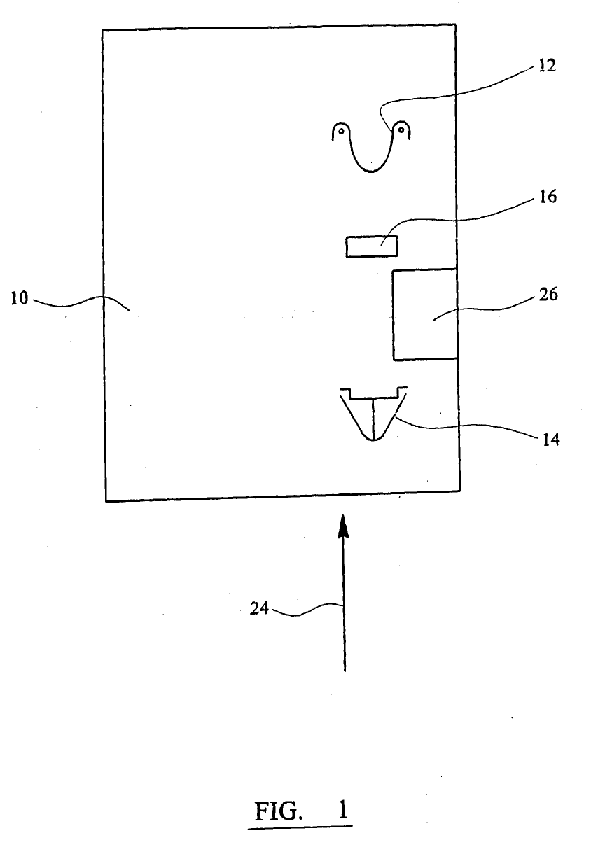

FIG. 1 is a schematic plan view of an ambulance floor 10;

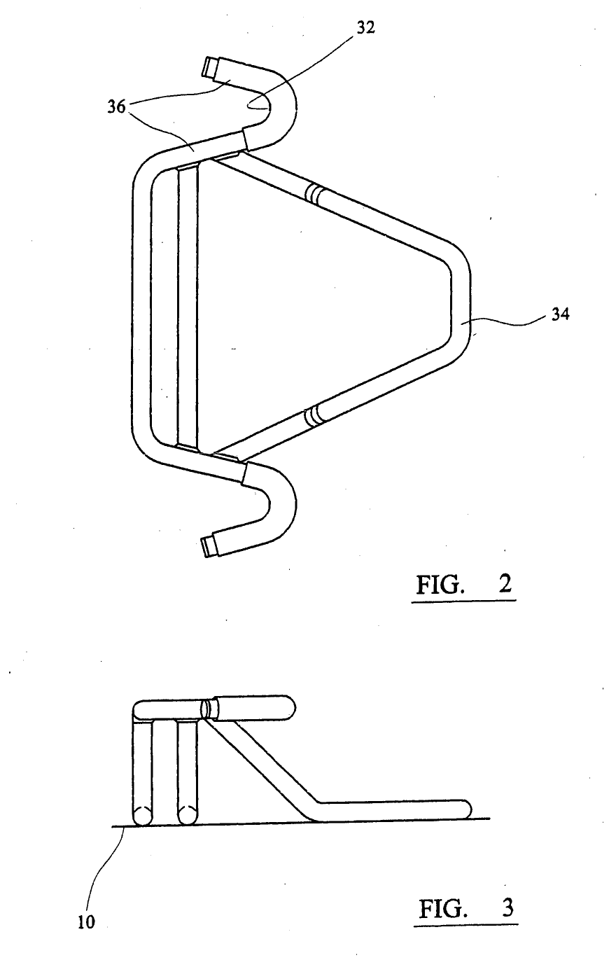

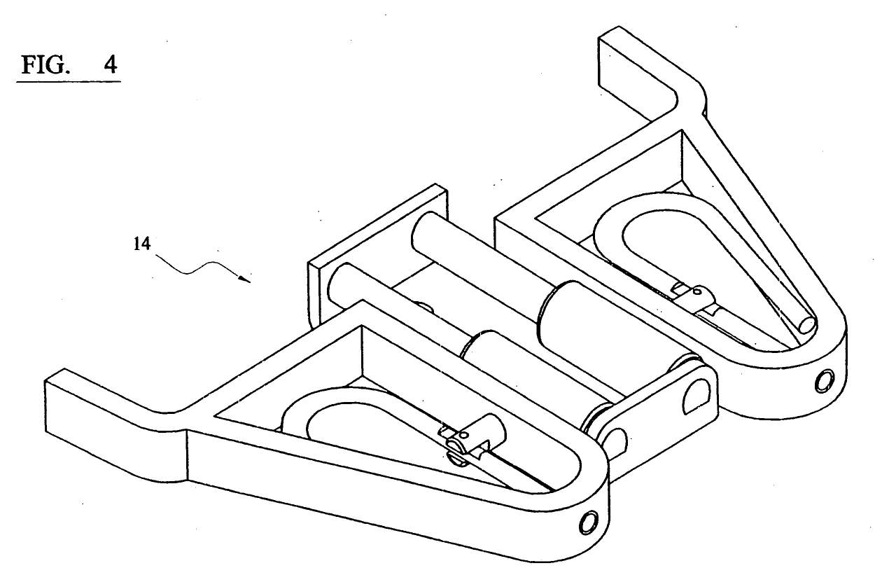

FIGS. 2 and 3 are a plan and a side view of an antler mounting 12 used to secure the front of the stretcher;

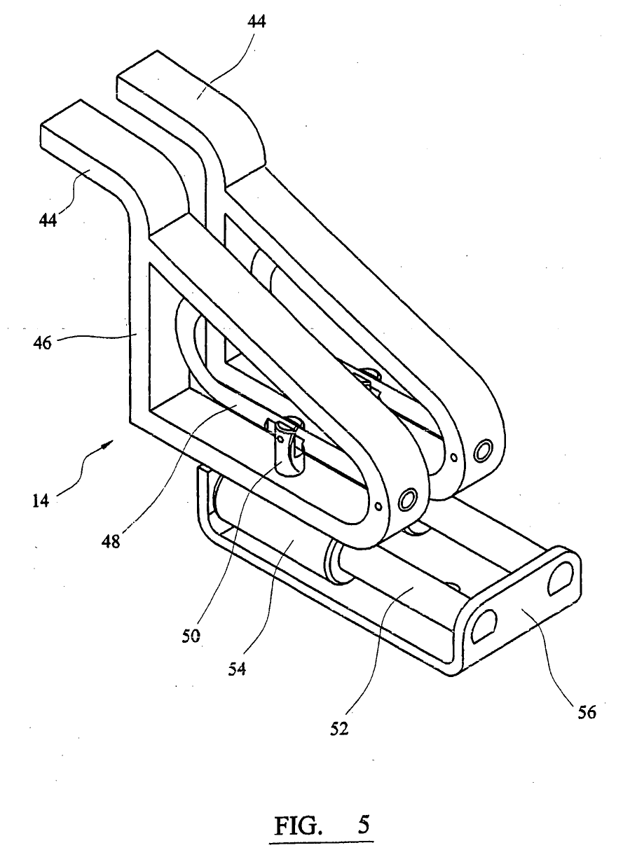

FIGS. 4 and 5 are a deactivated and an activated schematic view of a rear ratchet clamp 14;

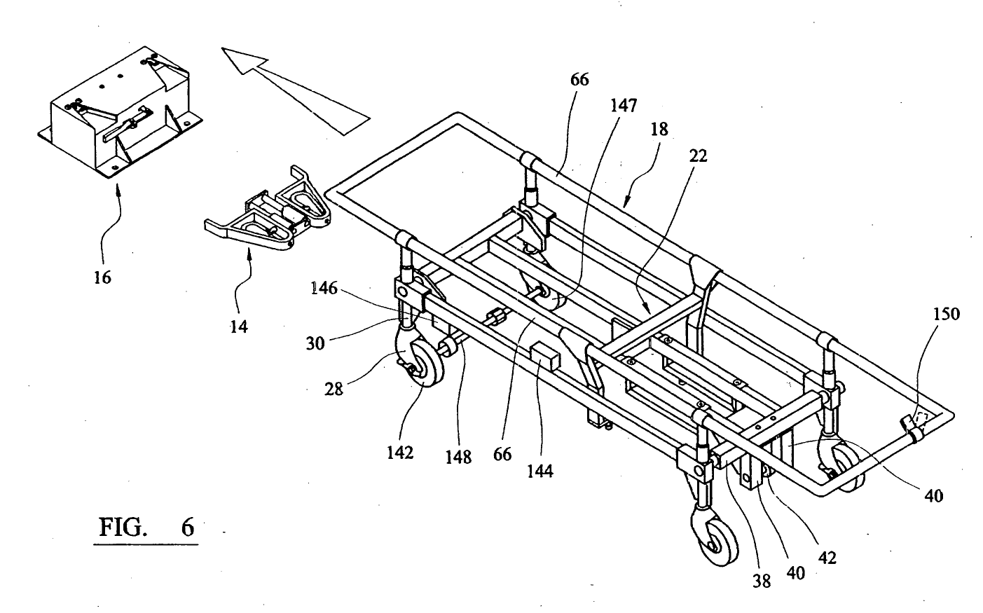

FIG. 6 is a schematic perspective view of a stretcher showing the direction of movement that is effected to connect the stretcher to the rear ratchet clamp 14 and a mid retaining box 16;

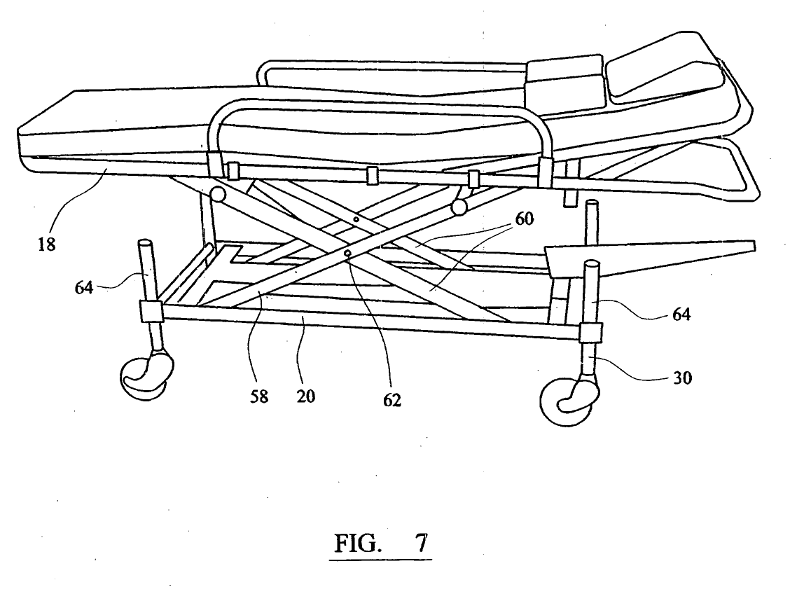

FIG. 7 is a side perspective view of a stretcher trolley showing how upper and lower frames 18 and 20 are moved relative to each other;

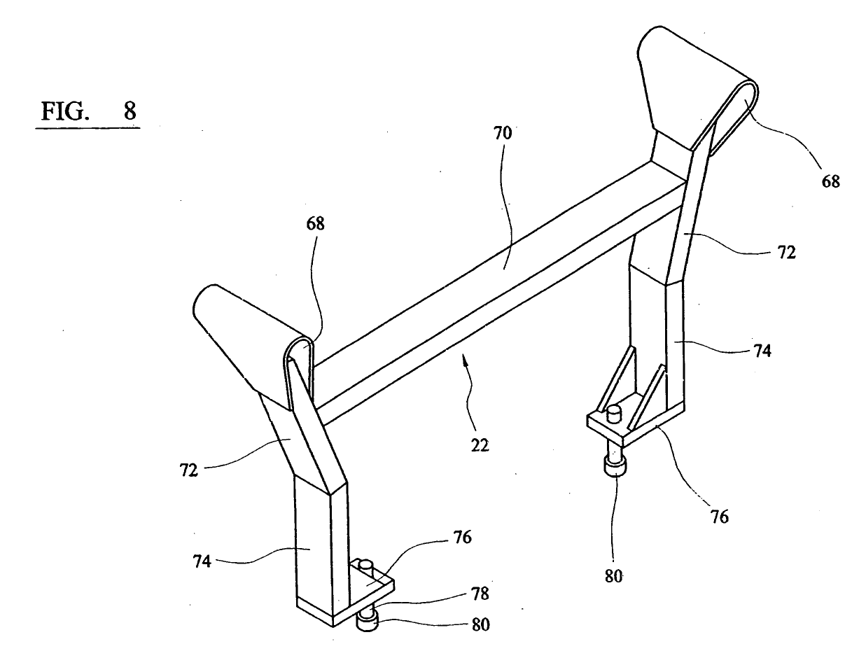

FIG. 8 is a perspective view of a bracket 22 that is secured to the upper frame of a stretcher in order that the upper frame can be secured to the mid retaining box;

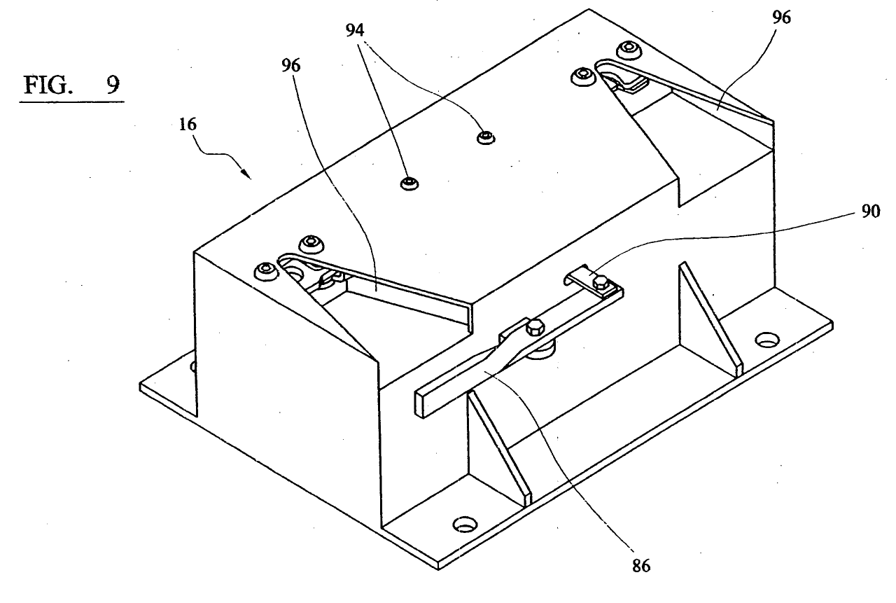

FIG. 9 is a first perspective view of the mid retaining box 16;

FIG. 10 is a perspective view showing the bracket 22 secured to the retaining box 16 with the rear of the stretcher being secured to the rear ratchet clamp 14;

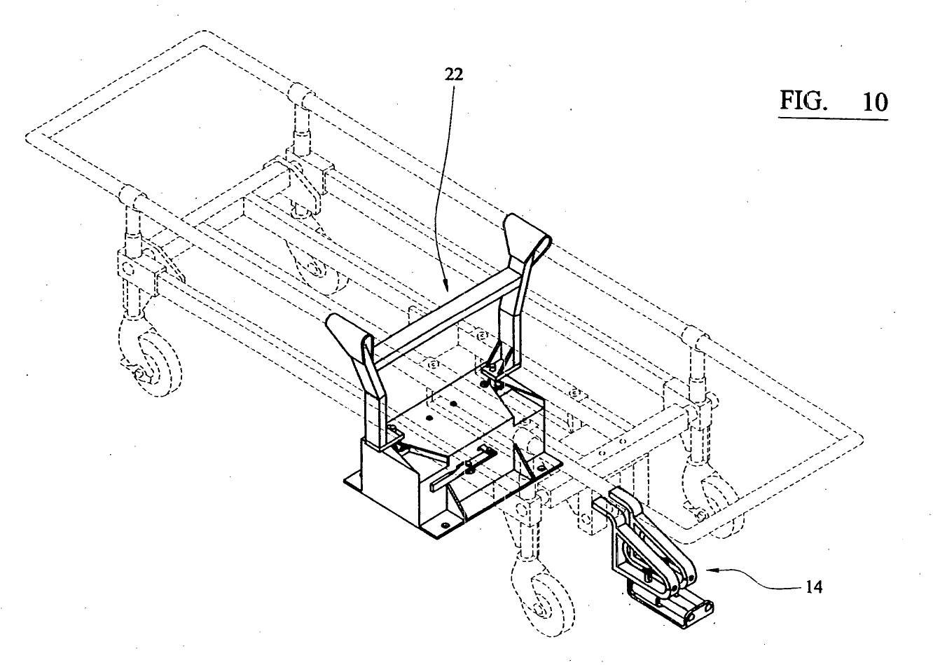

FIG. 11 is a perspective view showing the operative parts of the retaining box 16;

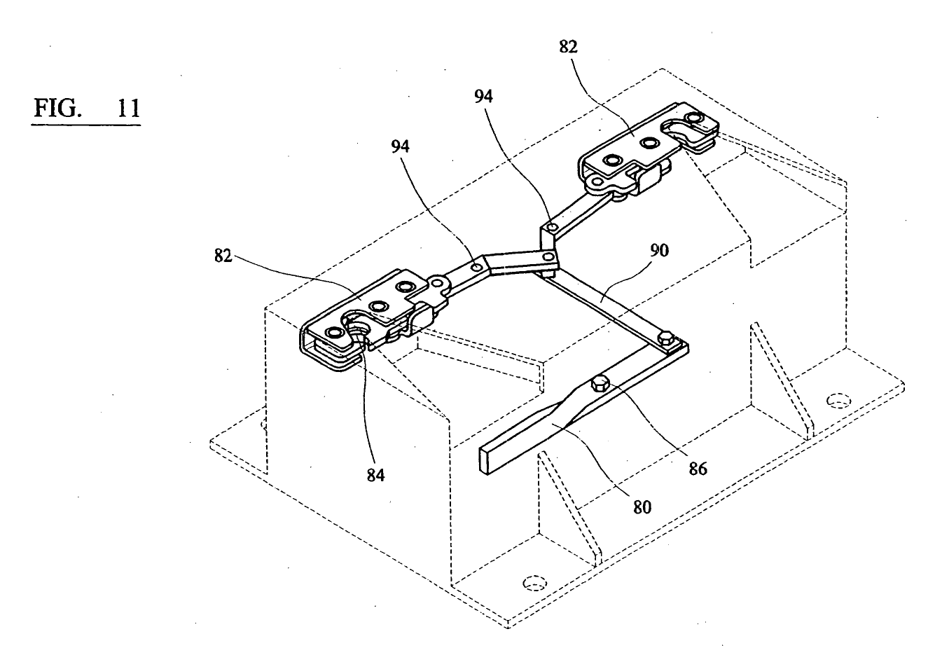

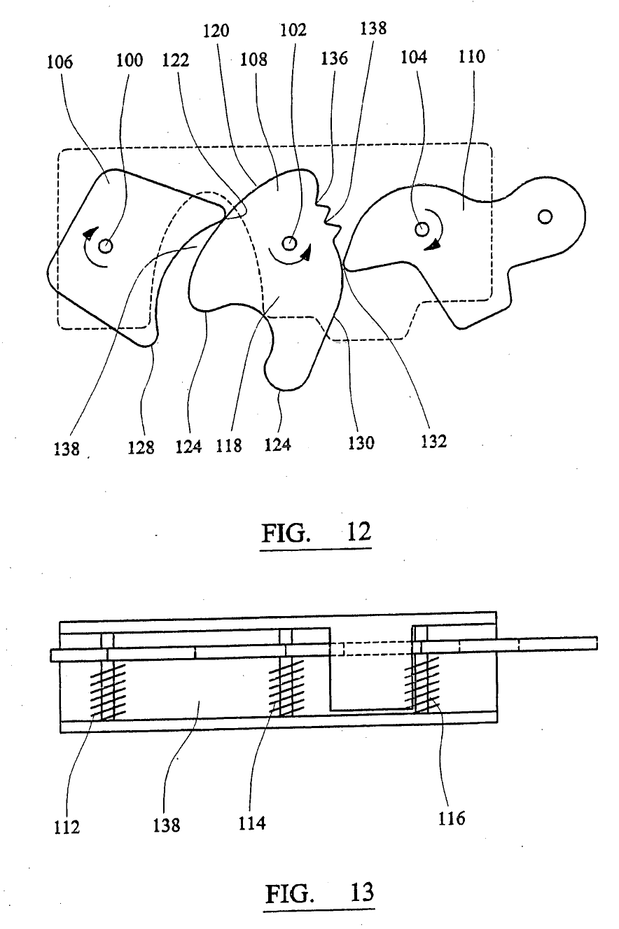

FIGS. 12 and 13 are schematic plan and end views of the latching mechanism of the retaining box 16 in the open position;

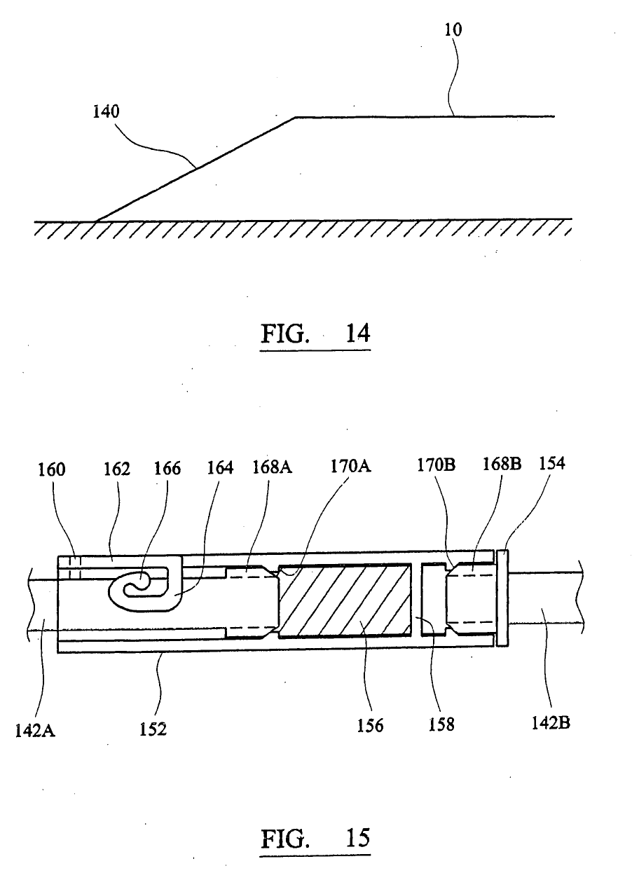

FIG. 14 is a schematic side view of a loading ramp 140 showing how a stretcher can be pushed up to rest on the ambulance floor 10; and

FIG. 15 is a side view of a part of the axles that come, from each front wheel showing the coupling assembly.

As shown in FIG. 1, a stretcher is collapsed and moved onto the ambulance floor in the direction of arrow 24. The front of the lower frame of the stretcher is secured by the antlers 12 and the rear of the lower frame of the stretcher is secured by the ratchet clamp 14. In the position shown, the stretcher is located over a wheel hub 26 that projects up into the ambulance. The front of the stretcher is guided by the antlers such that the forward wheel mountings 28 are located beneath the antlers with a tube 30 extending above those wheel mountings 28 being, located in arcuate recesses 32 of the antlers. Abutment of the tubes 30 with the recesses 32 resists relative forward movement of the stretcher in the ambulance and abutment of the wheel mountings 28 with the underside of the antlers resists upwards movement of the lower part of the frame. The recesses 32 are located above the floor 10 of the ambulance by appropriate supporting framework 34 that extends down and is secured to the floor 10. The arcuate recesses 32 are formed by rearwardly and outwardly diverging sections 36 that ensure that the tubes and therefore the stretcher is guided into the correct position.

As seen in FIG. 6, the lower frame of the stretcher includes a cross bar 38. A pair of brackets 40 extend downwardly from the cross bar 38 with an axle 42 extending between the lower portions of the brackets 40. In the operative position, the ratchet clamp 14 is in the position shown in FIG. 5 in which two hooks 44 extend over the axle 42 with downwardly extending bars 46 of the clamp resting against the rearwardly facing portion of the axle 42. The rear ratchet clamp resists upwards movement of the lower frame at the rear of the stretcher by abutment of the axle 42 with the hooks 44 and rearwards movement of the lower frame of the stretcher by abutment of the axle 42 with the bars 46.

In order to release the ratchet clamp 14 from the position shown in FIG. 5 to the position shown in FIG. 4, in which the hooks 44 and the bars 46 lie against the floor, an operative engages sprung members 48 with each hand to cause spigot pins 50 attached to the sprung members to be raised from the position shown in FIG. 5 to allow them to clear openings (not shown) in rods 52 such that cylinders 54 can slide rearwardly on the rods 52 towards an end stop 56 with pivotal movement of the cylinders 54 about the rods 52 being able to occur when the hooks 44 are clear of the axle such that the clamp is in the position shown in FIG. 4. In order to attach the ratchet clamp to the lower frame, the hooks and bars 44 and 46 are pivoted upwardly from the position shown in FIG. 4 and then slid along the rods 52 until the axial is engaged and the spigot pins 50 automatically snap into the openings in the rods 52 to hold the bracket in position.

Thus, with the rear ratchet clamp 14 and the antlers 12, the front and rear of the lower frame of the stretcher are held in position. However, what is desired by that holding is of course the retention of the upper frame in position and that is not directly achieved with either the antlers or the ratchet clamp.

In this respect, FIG. 7 illustrates the form of stretcher that it is intended to use the apparatus with and it comprises the upper frame 18 and the lower frame 20. In FIG. 7, these frames are shown spaced apart. However, the frames are able to move towards and away from each other as they are connected by a first pair of spaced, parallel linkages 58 and a second pair of cross linkages 60 that are also parallel with each other. The upper and lower end of each linkage 58 is pivotally connected, respectively, to the upper and lower frames 18 and 20 with adjacent linkages 58 and 60 from each pair being pivotally connected at point 62. Some movement of the rear pivot connections of the upper and lower members of each linkage in the extent of the general plane of the upper and lower frames is permitted to allow for the raising and lowering of the upper and lower frames relative to each other. Latches (not shown) are provided, or other control means may be provided to allow the frames to remain in their respective positions. In the position in which the stretcher is anchored into the ambulance, the upper frame rests and is located on upwardly extending bars 64 from each tube 30. For convenience, the connecting linkages are not shown in FIG. 6.

As shown in FIGS. 6 and 8, the bracket 22 is secured approximately midway along spaced side members 66 of the upper frame with the side members passing through and being secured to channels 68 formed in the bracket. A central cross bar 70 extends between and connects downwardly and inwardly extending bars 72 that are connected to each channel 68 and downwardly extending bars 74 extend vertically from the bar 72 in order that they clear and extend beneath the lower frame 20 when the frames are collapsed towards each other, as shown. At the bottom end of each bar 74 brackets 76 extend inwardly towards each other with a pin 78 extending down from each bracket 76 with the pin having an enlarged head portion 80. In the position shown in FIG. 10, the pins 78 abut a portion of the retaining box 16 to prevent relative, forwards or rearwards or side to side movement of the upper frame of the stretcher with respect to the ambulance and with the heads 80 abutting a portion of the retaining box 16 to prevent relative upwards movement. The manner in which this is achieved will now be described.

In the position shown in FIG. 11, slam latches 82 are in the closed position in which the pins 78 will extend through and be retained in their openings 84. To release the pins a lever 86 is moved forwardly to cause its rotation about a fixed pivot 88 which in turn causes a link 90 to move rearwardly. That movement of the link 90 causes links 92 that are pivotally connected to the link 90 to move about fixed pivots 94 to release the slam latches 82.

As shown in FIG. 9, the box 16 includes rearwardly and outwardly diverging channels 96 that ensure that the pins 78 are guided precisely into the awaiting open slam latches. The position of the open slam latches is shown in FIGS. 12 and 13.

A U-shaped bracket 98 includes three pivot pins 100,102,104 extending therethrough on which are respectively mounted first and second retaining plates 106 and 108 and a latch plate 110. Respective springs 112,114 and 116 bias the retention plate 106 in a clockwise direction, the retention plate 108 in an anti-clockwise direction and the latch plate 110 in a clockwise direction.

As a pin 78 of the bracket 22 abuts the camming surface 118 of the plate 108, that plate is urged against its spring bias in a clockwise direction with a curved surface 120 of the plate 108 pushing a cooperating surface 122 of the plate 106 in an anti-clockwise direction until the pin is retained in an enclosure defined by an arcuate surface 124 on the plate 108 and the almost abutting surfaces 126 of the plate 108 and the face 128 of the plate 106.

As the closing motion of the plate 108 occurs, a camming surface 130 of that plate urges the latch plate 110 in an anti-clockwise direction with a latch point 132 of the plate 110 resting first in a notch 134 and then in a notch 136 of the plate 108 to hold the parts in the closed position.

When the release lever 86 is actuated, the latch plate 110 is caused to move in an anti-clockwise direction to urge the latch point 132 out of engagement with the notches to cause the plates 106 and 110 to spring back to the position shown.

The space indicated as 138 is the region where, in use, the enlarged head of the pin 78 will be located.

Accordingly, it can be seen that the upper frame at an intermediate section from the ends, and generally in the middle section, is directly retained against forwards movement, rearwards movement, side to side movement and also rearwards movement and up and down movement with respect to the ambulance floor thus affording an extremely safe anchoring system for a stretcher in the ambulance.

In use, the stretcher 18 will move up the ramp 140, as shown in FIG. 14 until it rests on the horizontal floor 10 of the ambulance and is secured in position as previously described. The angle of the ramp 140 to the horizontal is typically of the order of 12 to 15° with the ramp being of 2 m length.

As shown in relation to FIGS. 6 and 15, the front wheels are connected together such that, in one mode, they are unable to rotate about the vertical axis provided by the wheel mountings 28 as a result of an axle 142 connecting the front wheels. A battery 144 mounted on the lower frame is able to power a motor 146 mounted on the lower frame in any well known manner. For instance, the motor may impart a drive via an induction force being applied to a magnet fast with the axle.

With a patient being mounted on the stretcher, the stretcher can be moved into the ambulance by an operator at the rear of the trolley controlling a lever 150 which initiates and varies the speed of rotation of the drive shaft from the motor and the speed of travel of the trolley. Accordingly an operator can concentrate on correctly aligning the trolley as it moves towards the ramp, up the ramp, and over the floor of the vehicle without having to exert any pushing force on the trolley. Similarly, the lever 150 can be moved in an opposite direction to initiate and vary the speed of reverse rotation of the axle to enable the operator to concentrate removal of the vehicle from the trolley. The motor may include a positive drive that prevents the axle from being able to rotate faster than that set by the lever to prevent runaway of the stretcher down the ramp.

Should the motor fail or should the stretcher be desired to be maneuvered in a traditional manner with all four stretcher wheel mountings being able to swivel about a vertical axis, it is possible to detach the connection effected by the axle. Such an attachment/detachment mechanism is shown in FIG. 15. The axle is comprised by shafts 142A and 142B extending from each wheel. A tube 152 is biased towards a flange 154 on the shaft 142B by a compression spring 156 that bears against the end of the axle 142A and a flange 158 formed internally of the tube 152. The tube 152 can slide on the shaft 142A (with splines 16A on the end of the shaft cooperating with grooves 170A on the internal surface of the tube) away from the flange 154 and against the action of the spring 156. That movement is also guided by a pin 160 fast with the axle 142A engaging with an axially extending slot 162 formed in the tube 152. When the tube 152 is clear of the end of the axle 142B and the splines 168A, the tube is rotated such that the pin 160 guides the tube in a rotational direction through a circumferential extent 164 of that slot until the pin comes to rest, and is held in a recess 166 of that slot in a well known bayonet locking manner. The tube 152 is returned to the position shown by appropriate twisting of the tube 152 and maneuvering of the tube 152 when the shafts 142A and 142B are axially aligned.

The tube may include grooves 170B arranged to co-operate with splines 168B on the shaft 142B to cause the two parts to rotate with each other. The ends of the splines 168A or grooves 170A or B or both may be inwardly or outwardly tapered respectively to ensure that they are able to readily engage with each other. If necessary, the stretcher can be pivoted slightly at the front end to ensure rotational alignment and engagement of the spines. The axial ends of the tube and shaft 142B may be devoid of splines or grooves to enable initial axial alignment with the operator then being able to remove his hand from the tube 152 to be able to stand up and effect the pivoting of the front of the stretcher with the spring 156 then urging the splines and grooves into cooperation.

In an alternative embodiment, a clutch, such as a magnetic clutch, may be actuated or released to cause axial rotation or axial freedom of movement between the shafts 142A and 142B. This clutch may be actuated by the battery.

In an alternative embodiment, short stub axles may extend from each wheel and be attached to or detached from fixed axles rotatable about a bearing mounting depending down from the adjacent lower frame portions of the stretcher. The drives and attachment/detachment between the stub axles may be as hereinbefore described.

In an alternative embodiment, the or each driven wheel may have its own motor mounted on the wheel arranged, when powered, to drive that wheel in a manner as previously described.

In a further embodiment, the or two or more wheels may be able to be retained with their axle in a fixed position relative to the remainder of the stretcher, for instance by the foot of an operator actuating a mechanism that allows a sprung detent on one of the wheel assemblies or mounting shaft for that wheel to spring into a recess on the other of the wheel assembly or mounting shaft when the wheel axis rotates about an upwardly extending axis (such as by maneuvering the trolley) to align the detent and recess. The detent and recess may be released by, for instance, an operator causing the detent to be pushed back against the spring force and held clear of the recess. This may be done by the foot of an operator moving a lever in one direction to depress the detent and then in a transverse direction to hold the lever against an abutment to retain the detent in a depressed position against the sprung bias.

The battery may be able to be recharged by a connection on the stretcher automatically being brought into engagement with a power point on the vehicle as the stretcher is not accurately moved into its fixed position in the vehicle.

It will be appreciated that the wheels could be powered in situations other than maneuvering the stretcher into and out of a vehicle, for instance when moving the stretcher up a slope or down a steep slope (in order to take advantage of any braking effect of the motor).

Furthermore, it will be appreciated that not all of the power to move the stretcher need be applied by the motor and an operator could assist in providing the necessary power.

Should the motor fail or, in any event, the trolley may be movable in a conventional manner by causing all wheels to be able to rotate about their upwardly extending axes or indeed by locking the wheels about the upright axis.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment (s). The invention extends to any novel one, or any novel combination, of the features disclosed in this specification (including any accompanying claims, abstract and drawings), or to any novel one, or any novel combination, of the steps of any method or process so disclosed.

1-36. (canceled)

37. A trolley comprising:
a patient support;
at least three wheels supporting the patient support and which enable the trolley to be moved, at least one of the wheels is a powered wheel configured to operate in a retained mode in which the wheel is constrained to rotate about a first axis only with respect to the trolley, the trolley is configured, in the retained mode at least, to power the wheel to rotate about the first axis, the wheel also being able to operate in a released mode in which the wheel is able to rotate freely about the first axis when the trolley is being moved manually and a second axis extending upwardly with respect to the first axis; and
an actuation device arranged to cause the powered wheel to be in the retained or the released mode, wherein the actuation device has a reciprocatable member arranged to move in the axial direction of the first axis to cause the wheel to be in the retained mode in a first axial position of a reciprocatable member, such that the wheel is held in the retained position in one position of the second axis only, and to be in the released mode in a second axial position of the reciprocatable member.

38. A trolley as claimed in claim 37 in which, in the retained position, the axis of the powered wheel is arranged always to be at the same angular orientation with respect to the trolley.

39. A trolley as claimed in claim 37 in which the actuation device is arranged to cause the powered wheel to be in both the retained and the released mode.

40. A trolley as claimed in claim 37 in which the actuation device further includes a clutch selectively actuatable to cause the powered wheel to be in the retained or released mode.

41. A trolley as claimed in claim 37 in which the actuation device further includes a clutch arranged to act on an axle extending from the powered wheel in the direction of the first axis.

42. A trolley as claimed in claim 37 in which the reciprocatable member is also movable in a rotational direction about the first axis.

43. A trolley as claimed in claim 37 in which the reciprocatable member is arranged to be axially movable on an axle of the powered wheel.

44. A trolley as claimed in claim 37 in which the reciprocatable member is arranged to move axially and rotationally about the first axis when moving between the retained and the released mode.

45. A trolley as claimed in claim 37 further comprising a motor to power the powered wheel.

46. A trolley as claimed in claim 45 in which the motor is mounted on an axle connected to the powered wheel.

47. A trolley as claimed in claim 45 in which the motor is mounted on the powered wheel.

48. A trolley as claimed in claim 45 in which an axle from the powered wheel includes a magnetic portion and the motor is arranged to induce a current to cause rotation of the axle.

49. A trolley as claimed in claim 37 in which at least two wheels of the trolley are movable between the retained and the released modes.

50. A trolley as claimed in claim 37 in which a single motor is arranged to power at least two of the wheels, and each of which is movable between the retained and the released modes.

51. A trolley as claimed in claim 50 in which each wheel has its own axle extending in the direction of the first axis, in which each axle is arranged to be held in the retained or in the released mode.

52. A trolley as claimed in claim 50 in which each wheel is arranged to be simultaneously in the released or the retained mode such that it is not possible to cause only one of the wheels to be in the retained mode.

53. A trolley as claimed in claim 37 further comprising an automatic release for the powered wheel when at least in the retained mode.

54. A trolley as claimed in claim 37 further comprising a device to free the powered wheel when power to the wheel fails.

55. A method of operating a trolley as claimed in claim 37, comprising:
moving the powered wheel from the released mode to the retained mode;
powering the powered wheel; and
freeing the powered wheel when the power fails such that the powered wheel is able to rotate when not powered when the trolley is moved by manual force only.

56. A method as claimed in claim 55 comprising freeing the powered wheel automatically when the power fails.
